(19) United States
(12) Patent Application Publication
(10) Pub. No.: US 2025/0091847 A1
(43) Pub. Date: Mar. 20, 2025

(54) ROLLER TOP STACKER

(71) Applicant: Ballymore Company, Inc., Coatsville, PA (US)

(72) Inventor: William F Frame, Coatsville, PA (US)

(21) Appl. No.: 18/891,784

(22) Filed: Sep. 20, 2024

Related U.S. Application Data
(60) Provisional application No. 63/583,882, filed on Sep. 20, 2023.

(51) Int. Cl. B66F 9/07; B66F 9/12

(52) U.S. Cl. CPC B66F 9/07; B66F 9/122

(57) ABSTRACT

A roller top stacker having a moveable lift comprising a boom assembly. The roller top stacker includes a roller top assembly mounted to the boom assembly and a drive system for raising roller top assembly between a raised and lowered position. The roller top assembly has a top surface comprising a pattern of openings through which rollerballs protrude when in a raised position and in a lowered position which the rollerballs do not protrude.

### CROSS REFERENCE TO RELATED APPLICATIONS

This application also claims the benefit of U.S. Provisional Application No. 63/583,882, filed Sep. 20, 2023. The entire disclosure of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The Invention relates to a roller top portable dock lift having a roller top or stacker assembly.

### SUMMARY

The invention relates to a roller top stacker having a moveable lift comprising a boom assembly. The roller top stacker includes a roller top assembly mounted to the boom assembly and a drive system for raising roller top assembly between a raised and lowered position. The roller top assembly has a top surface comprising a pattern of openings through which rollerballs protrude when in a raised position and in a lowered position which the rollerballs do not protrude.

The roller top assembly may include a moveable assembly on which the rollerballs are mounted and which travels vertically between the raised and lowered positions, a sled that is moveable horizontally within a base. The sled may include at least one ramp having an inclined portion and a horizontal portion and the moveable assembly comprises at least one wheel which engage with a respective ramp. A linear actuator may be provided for moving the moveable assembly horizontally with the base, the linear actuator being connected to the sled. In one form of the invention a top surface and the base form an enclosure for the sled and the moveable assembly.

### BRIEF DESCRIPTION OF THE DRAWINGS

The embodiments will be described in detail with reference to the following drawings in which like reference numerals refer to like elements wherein:

FIG. 1 shows a front perspective view of a roller top lift in accordance with the present invention.

FIG. 2 shows a rear perspective view of a roller top lift of FIG. 1.

FIG. 3 shows a side elevational view of a roller top lift of FIG. 1.

FIG. 4 shows a top view of a roller top lift of FIG. 1.

FIG. 5 shows a second preferred embodiment of a roller top lift of the present invention.

FIG. 6 shows a cross-sectional view of the roller top assembly taken along line 6-6 of FIG. 5 showing the moveable plate in the lowered position.

FIG. 7 shows a cross sectional view of the roller top assembly of FIG. 6 showing the moveable plate in the raised position.

FIG. 8 shows a cross-sectional view of the roller top assembly taken along line 8-8 of FIG. 5 showing the moveable plate in the lowered position.

FIG. 9 shows a cross sectional view of the roller top assembly of FIG. 8 showing the moveable plate in the raised position.

FIG. 10 shows an exploded perspective view of the roller top assembly.

### DETAILED DESCRIPTION

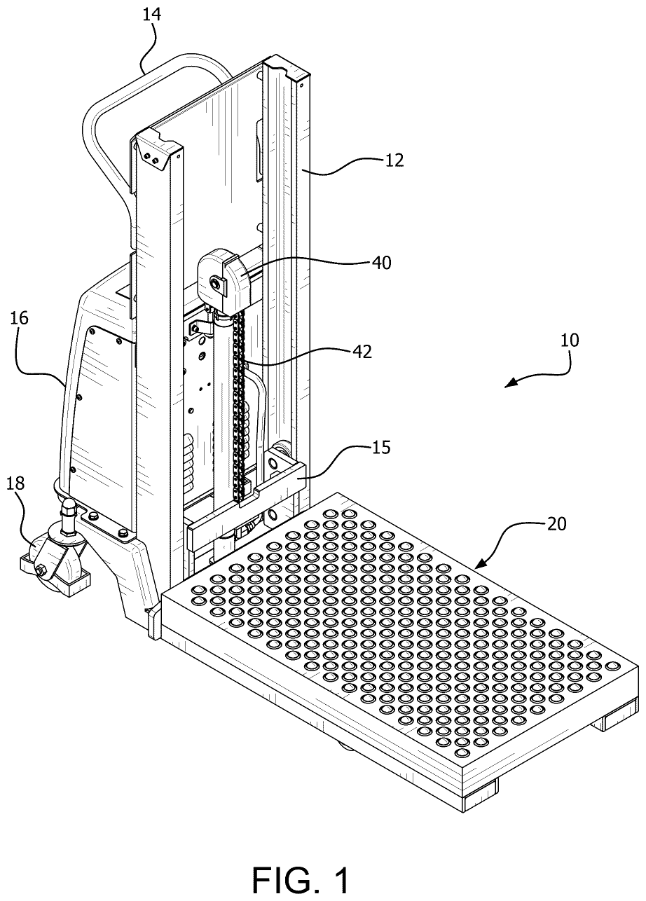

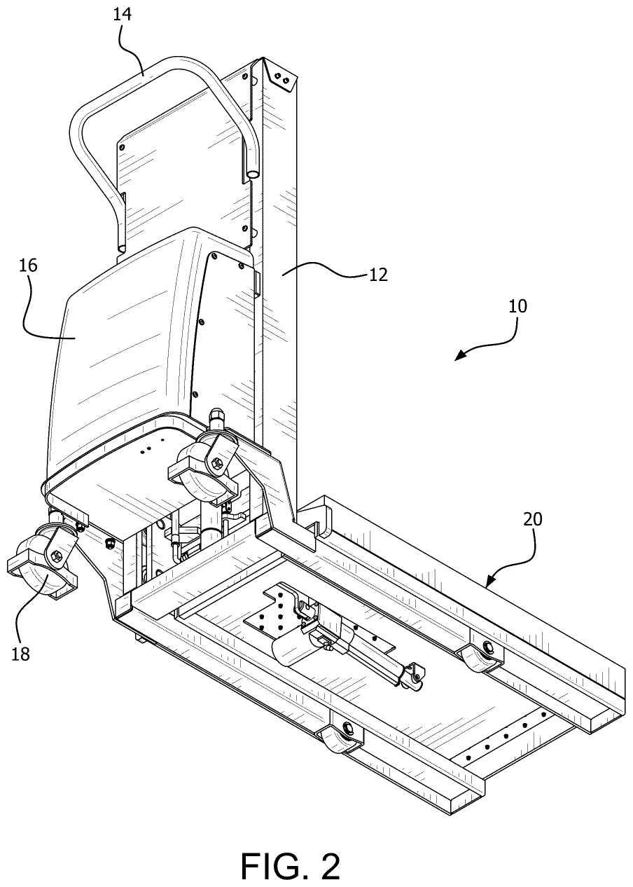

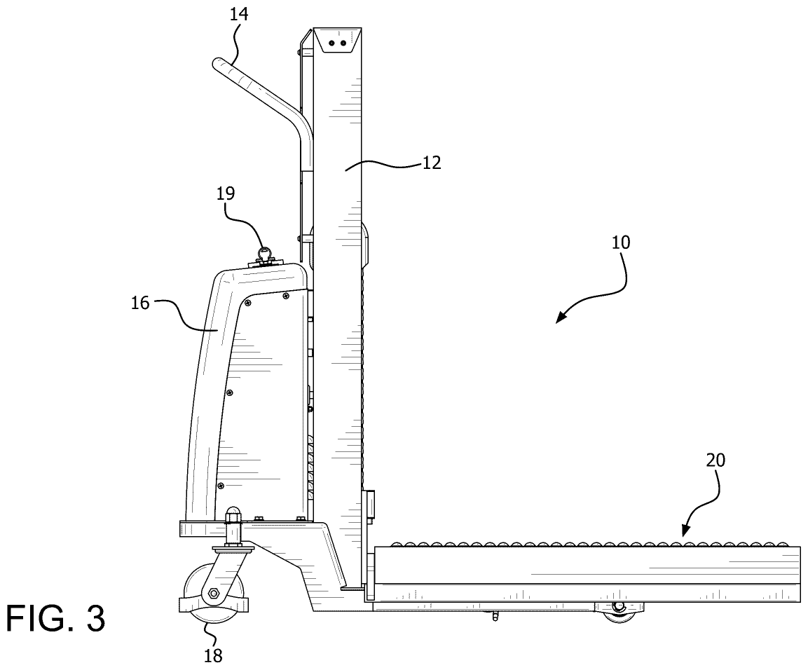

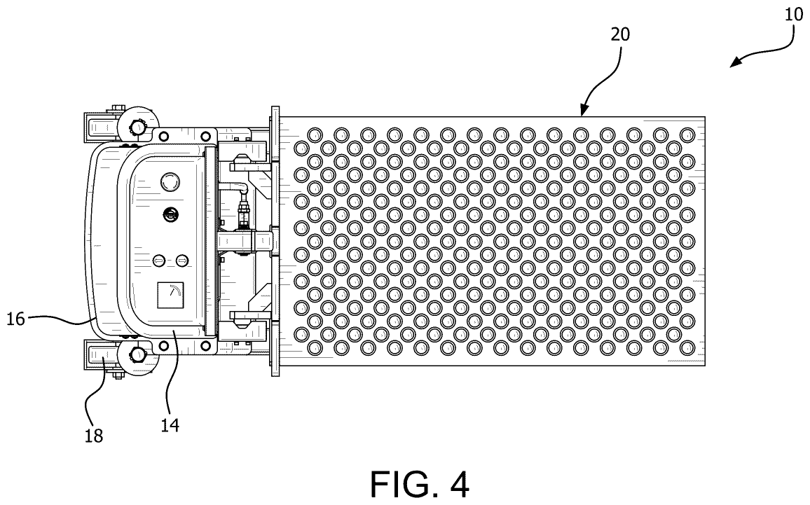

As shown in FIGS. 1 through 4 and 6 through 10, there is shown a roller top stacker 10 in accordance with the present invention. The roller top stacker 10 comprises a lift portion and a roller top stacker assembly 20.

The lift portion of the roller top stacker 10 comprises a boom assembly 12 and rear wheels 18 mounted thereto at the rear of boom assembly 12 for allowing the stacker 10 to be portable. The boom assembly comprises a traveler 15 which travels up and down the boom assembly 12 which is attached to the roller top stacker assembly 20 and permits the roller top stacker assembly to be raised and lowered as desired. the forks and front wheels 19 mounted at the front of the forks.

A drive system and controller 16 is mounted to the boom assembly 12. The drive system is shown as a chain drive 40 and chain or belt 40 which is operated by controller 16 to raise and lower the roller top stacker assembly 20. The roller top stacker 10 is shown in a lowered position of FIG. 1. The drive system 16 is preferably DC battery powered and preferably does not require external power for operation. Other lift drives are contemplated and fall within the scope of the present invention.

The roller top stacker 10 is controlled by operator controls 19 located on the drive system and controller 16. A handle 14 mounted to the vertical lift assembly 12 is provided for manually moving the stacker 10 when desired.

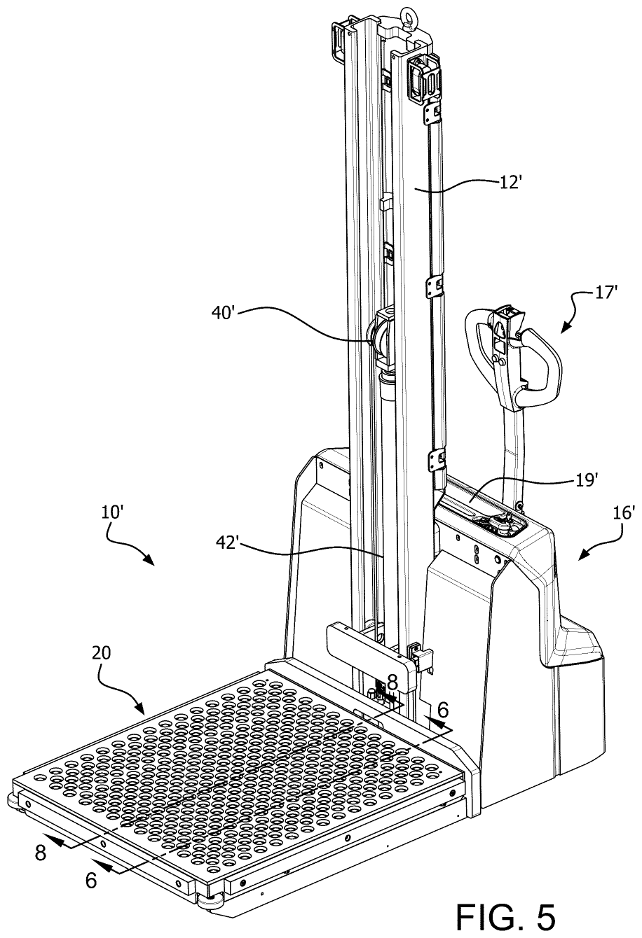

In FIG. 5 there is shown an alternate embodiment of the roller top lift 10′ invention where like reference numerals with primes (′) indicate like elements. Roller top stacker 10′ comprises a slightly different belt drive 40′ having a belt 42′. In addition the Roller top lift 10′ can be moved via a powered drive controlled by handle 17′ for maneuvering the lift.

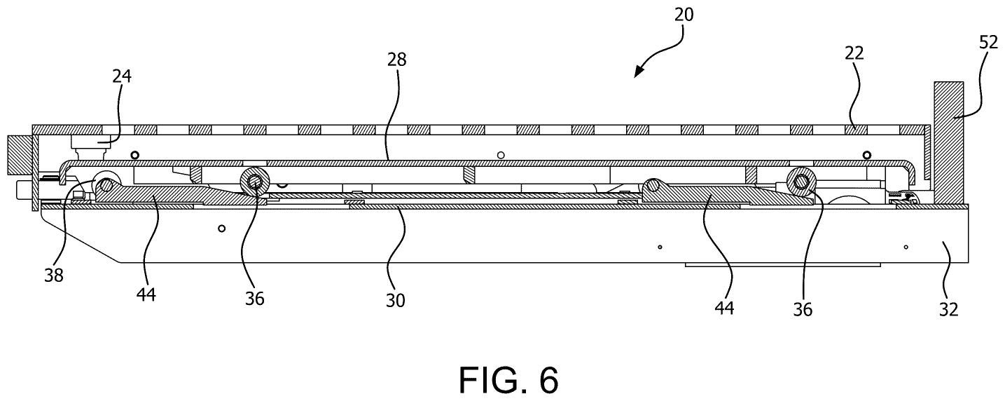

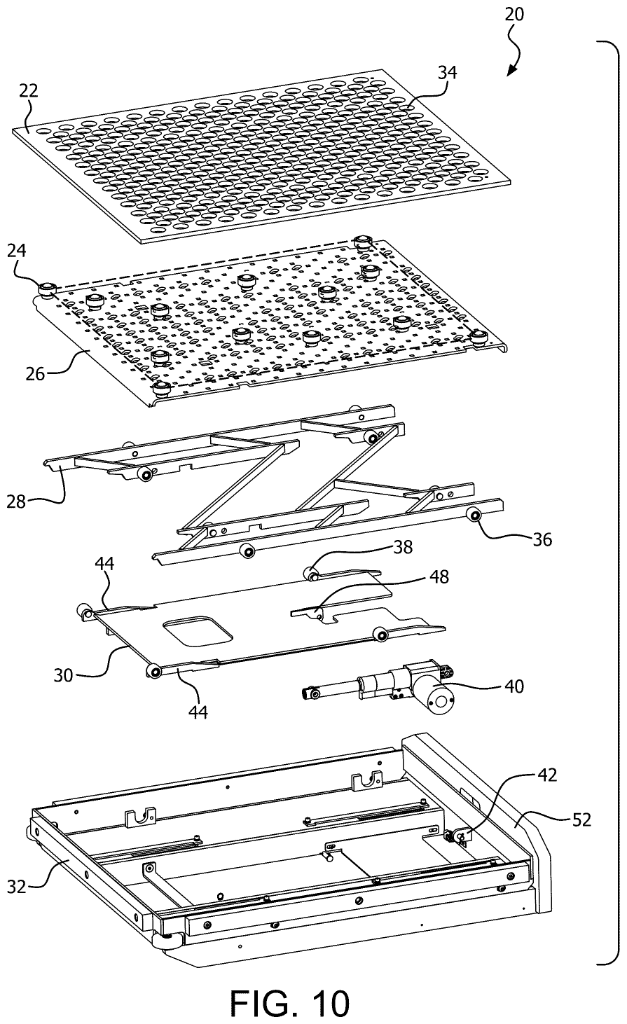

Turning now to FIGS. 6-10, the roller top stacker assembly 20 is shown in more detail. As shown in FIG. 10 the roller top stacker assembly 20 comprises a base 32, a horizontally moveably sled 30, a linear actuator for moveable sled 30, a frame 28 upon which a roller plate 26 is disposed, and a top plate 22 having a series of spaced openings 34 through which rollers 24 mounted on roller plate 26 protrude when the frame 28 and plate 26 are raised and lowered as described in greater detail below.

The base 32 of the roller top assembly 20 includes an upstanding member 52 which attaches to traveler 15 of the boom assembly for raising and lowering the roller top assembly to a height desired by the operator (via the controls 19) to load onto (or unload from) a payload onto the top plate 22 of the roller top assembly 20. The base 32 also includes a connection, such as clevis 42, to which the linear actuator 40 is mounted.

The linear actuator includes an actuator arm 46 which extends from and retracts into the actuator 40. The end of the actuator arm is connected to a tab 48 located on moveable sled 30. In this way, extending the actuator arm 46 serves to move the sled 30 horizontally back and forth within the base 32. The sled includes wheels 38 for facilitating the movement of the sled as the wheels contact the upper surface of the floor of the base 32.

The sled 20 also includes a plurality of ramps 44 which expend upwardly from the sled 30. The ramps 44 have an inclined portion and a horizontal portion as shown. The ramps co-act with the roller top plate assembly as described in greater detail below. The roller top plate assembly comprises frame 28, roller plate 26, and top plate 22.

The frame 28 and plate 26 are connected together and form a moveable assembly. Disposed on the frame 28 are wheels or rollers 36 which are each aligned with respective ramps 44 of sled 30. A plurality of spaced roller balls 24 are attached on an upper surface of the plate 26 (only some rollers are shown in FIGS. 6-10 for clarity purposes; the full set is shown in FIGS. 1-5).

The top plate 22 rests on the base 32 and enclose the moveable assembly of elements 24 and 28 within the base 32. The top plate comprises a series of spaced openings 34 aligned with respective roller balls 24 allowing a roller 24 to protrude through one of the respective opening 34.

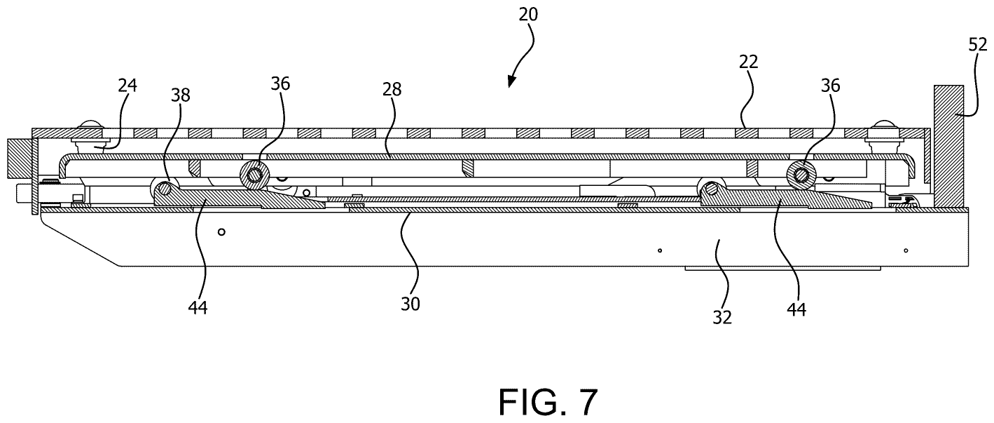

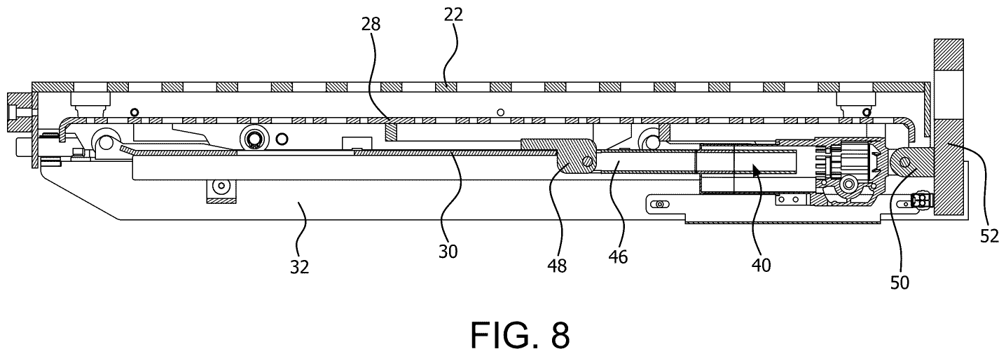

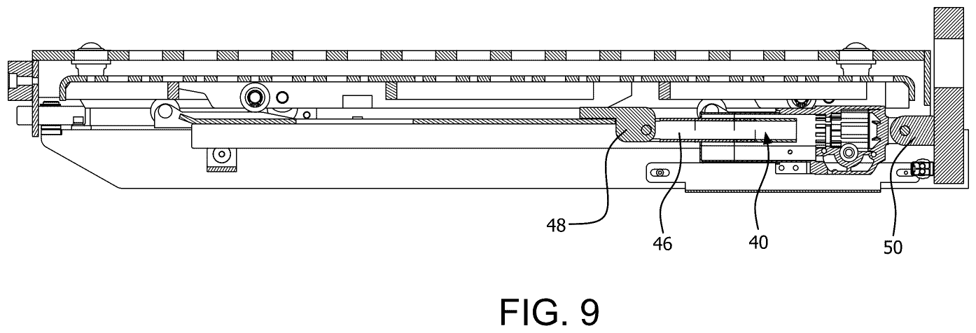

Referring to FIGS. 6-9, the operation of the roller top lift assembly 20 will be described in more detail. FIGS. 6 and 8 show the moveable plate assembly in the lower position, while FIGS. 7 and 9 show the moveable plate assembly in the lower position. In the lower position, the actuator arm 46 is extended out from the actuator 40 which positions the sled 30 toward the front of the base 32 with the wheels 36 of the sled adjacent the bottom portion of the inclined portions of the ramps 44. In this lowered position, the movable assembly of plate 26 and frame 28 is positioned lower in the base 32 such that the roller balls 24 do not protrude through the openings 34 of the top plate. The top plate thus presents a flat surface on which a load may be carried securely

When it is desired to load or unload a payload sitting on the top plate 22, the user uses the controls 19 to extend the actuator arm 46. Retracting the actuator arm 46 serves to move the sled 30 via the connection tab 48 rearwardly in the base 32 via the wheels 38. In this way, the inclined surfaces of the ramps 44 disposed on the top surface of the sled 30 engage with the wheels 36 of the frame 28 and plate 26. As the sled 30 is pulled rearwardly by the actuator arm 46, the wheels 36 travel up the inclined portion of the ramps until the wheels rest of the horizontal surface of the ramps 44. This serves to raise the frame 28 and roller plate 26 within the base 32 so that the roller balls 24 protrude from the openings 34 located on the top plate 22, as shown in FIGS. 7 and 9. In this raised position an operate may readily load and unload a payload on the top plate via the functionality of the protruding roller balls 24.

To reverse this process and lower the plate 28 and roller balls 24 so they no longer protrude through the openings 34, the actuator arm is extended moving the sled forwardly in the base 32 and permitting the wheels 36 to roll down the inclined portions of the ramps 44, thus lowering frame 28 and roller plate 26.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A roller top stacker comprising:
a moveable lift comprising a boom assembly;
a roller top assembly mounted to the boom assembly;
a drive system for raising roller top assembly between a raised and lowered position;
the roller top assembly having a top surface comprising a pattern of openings through which rollerballs protrude when in a raised position and in a lowered position which the rollerballs do not protrude.

2. A roller top stacker according to claim 1 wherein roller top assembly comprises a moveable assembly on which the rollerballs are mounted and which travels vertically between the raised and lowered positions, a sled that is moveable horizontally within a base.

3. A roller top stacker according to claim 2 wherein the sled includes at least one ramp having an inclined portion and a horizontal portion and the moveable assembly comprises at least one wheel which engage with a respective ramp.

4. A roller top stacker according to claim 3 further comprising a linear actuator for moving the moveable assembly horizontally with the base, the linear actuator being connected to the sled.

5. A roller top stacker according to claim 4 wherein the top surface and the base form an enclosure for the sled and the moveable assembly.

6. A roller top for a lift comprising:
a roller top assembly mounted to the boom assembly, the roller top assembly having a top surface comprising a pattern of openings through which rollerballs protrude when in a raised position and in a lowered position which the rollerballs do not protrude.

7. A roller top stacker according to claim 6 wherein roller top assembly comprises a moveable assembly on which the rollerballs are mounted and which travels vertically between the raised and lowered positions, a sled that is moveable horizontally within a base.

8. A roller top stacker according to claim 7 wherein the sled includes at least one ramp having an inclined portion and a horizontal portion and the moveable assembly comprises at least one wheel which engage with a respective ramp.

9. A roller top stacker according to claim 8 further comprising a linear actuator for moving the moveable assembly horizontally with the base, the linear actuator being connected to the sled.

10. A roller top stacker according to claim 9 wherein the top surface and the base form an enclosure for the sled and the moveable assembly.
